(19) United States
(12) Patent Application Publication
(10) Pub. No.: US 2005/0212234 A1
(43) Pub. Date: Sep. 29, 2005

(54) Shopping cart extender

(76) Inventor: Ryan McFarland, Rapid City, SD (US)

Correspondence Address: Gene R. Woodle, 3516 Woodle Drive, Rapid City, SD, 57702, US

(21) Appl. No.: 10/807,980

(22) Filed: Mar. 23, 2004

(51) Int. Cl. B62B 3/04

(52) U.S. Cl. 280/33.992

(57) ABSTRACT

Embodiments of a shopping cart extender are disclosed. The shopping cart extender may be affixed to the top front of a conventional shopping cart such that it may be engaged in a vertical position such that the top of the shopping cart extender is level with the top of the handle of the shopping cart. When the extender is in an upright position, it forms a securing surface which is level with the rear of the cart and has side holders such that materials may be securely carried on the top of the cart and not slide off. The shopping cart extender is rotatable such that it rotates back into the shopping cart and does not interfere when the shopping cart is nested with another shopping cart.

### BACKGROUND OF THE INVENTION

1. Field of the Invention

The present invention relates generally to shopping carts and more specifically to an extender which makes the front of the shopping cart level with the rear of the shopping cart.

2. Background Information

In the United States and throughout the world, thousands of shopping carts are used in grocery stores, home supply stores, and a variety of other types of stores Shopping carts are generally made with a tubular metal frame with four caster type wheels affixed to the bottom of the frame. The basket portion of the shopping cart is ordinarily made from welded wire. Shopping carts are ordinarily made such that they nest. This is, the forward end of one shopping cart may be pushed through the rearward end of another shopping cart such than a number of shopping carts may be nested to take up a fraction of the room the shopping carts would take up if they didn't nest.

In order to make the nesting of shopping carts possible, the forward end of the shopping cart is lower than the handle portion of the rearward end of the shopping cart and the forward end of the shopping cart is also narrower than the rearward portion of the shopping car. In a great many instances, a person using a shopping cart collects items which are too long to fit within the basket of the shopping cart. Typically, such persons attempt to carry the long items balancing upon the top of the handle of the shopping cart and the forward top of the basket. Such a configuration is very unstable and invariably leads to one or more of the items falling from the top of the cart.

The invention presented in the present application is believed to solve, in a simple and effective fashion, problems which have long plagued persons using a shopping cart to carry items which are too long to fit within the basket of the shopping cart: a shopping cart extender which is affixed to the front of the shopping cart and which may be flipped up such that the extender is at the same height as the top of the handle of the shopping cart. The shopping cart extender further has ears at either end which protrude upward higher than the top of the handle of the shopping cart. These ears prevent long items resting upon the shopping cart extender from slipping off of the shopping cart extender. The shopping cart extender also automatically flips down to allow the nesting of several shopping carts which have the shopping cart extender.

The ideal shopping cart extender should provide a method of providing a convenient carrying surface for items which are too long to fit within the basket of a shopping cart. The ideal shopping cart extender should be capable of being flipped up to allow the carrying of long items or flipped down for normal shopping cart operation and nesting. The ideal shopping cart extender should also include a feature which prevents long items from sliding off of the shopping cart extender when in use. The ideal shopping cart extender should also be simple, rugged, inexpensive, and easy to use.

### SUMMARY OF THE INVENTION

The shopping cart extender of the instant invention is made as an attachment to a conventional shopping cart. Such conventional shopping carts are of the type which have a frame with a handle at the top rear, four wheels on the base (usually two fixed wheels in the rear and two caster type wheels in the front), and a wire basket above the wheels and forward of the handle. Because such shopping carts are intended to be nestable, the forward end of the basket is lower than the top of the handle and the basket and the frame gradually gets smaller from the rear of the shopping cart to the front of the shopping cart. The shopping cart is not intended to be a part of the invention. The longitudinal plane of the shopping cart is considered a vertical plane passing through the midpoint of the handle.

The shopping cart extender of the instant invention is a single piece made from a cylindrical steel bar bent into the appropriate shape. The bar is bent into a generally rectangular shape with an open bottom. The two bottom ends of the bar are bent into the shape of a hook which is slightly open upward. Above the hook, the bar is bent in the opposite direction to form a catch which is approximately a semicircle which opens forward and slightly downward. The bar is bent above the catch to a position which is slightly forward of vertical. These bends are made in a plane which is perpendicular to the longitudinal plane of the shopping cart. The bar extends upward from the catch to a point slightly higher than the height of the top of the handle. The bar is then bent into the shape of a “U” which opens downward. This bend is made roughly perpendicular to the sides of the basket. The bar is then bent to a horizontal angle. The other end of the bar is bent in a similar fashion.

Conventional shopping carts have a top bar which runs around the circumference of the top of the basket. This top bar is generally horizontal. Shopping carts further have a second top bar which is parallel to and beneath the top bar. The hook of the shopping cart extender may be forced upward and rearward over the front portion of the second top bar. This holds the shopping cart extender in position upon the front portion of the basket and the shopping cart extender is rotatable about the second top bar toward the handle and downward to the inside of the basket. The shopping cart extender may be rotated upward and forward such that the catch portion engages the top bar of the shopping cart. The releasable catch holds the shopping cart extender in a position which is slightly forward of vertical.

When the catch is engaged, the horizontal portion of the shopping cart extender (the carrier) is parallel with the handle of the shopping cart and the top of the carrier is the same height as the top of the handle. The “U” shaped portions of the shopping cart extender (the holders) extend upward such that they are higher than the carrier and at the ends of the carrier. When the shopping cart is nested with another shopping cart, the catch automatically disengages and the shopping cart extender rotates downward and rearward until it is out of the way.

In operation, the operator lifts the shopping cart extender and rotates it upward and forward until the catch engages the top bar of the shopping cart. The operator may then load items which are too long to fit into the basket such that they rest upon the carrier of the shopping cart extender and the top of the handle of the shopping cart. Because the carrier and the handle are at the same height, the items do not tend to slide off of the cart as they would without the shopping cart extender. In addition, the holder portions of the shopping cart extender act to prevent the items from sliding sideways off of the shopping cart.

In a second embodiment, a pair of ears may be affixed to either end of the handle such that the ears protrude upward from the handle and further act to secure a load on top of the shopping cart.

One of the major objects of the present invention is to provide a shopping cart extender providing a convenient carrying surface for items which are too long to fit within the basket of a shopping cart.

Another objective of the present invention is to provide a shopping cart extender capable of being flipped up to allow the carrying of long items or flipped down for normal shopping cart operation and nesting.

Another objective of the present invention is to provide a shopping cart extender which prevents long items from sliding off of the shopping cart extender when in use.

Another objective of the present invention is to provide a shopping cart extender which is simple, rugged, inexpensive, and easy to use.

These and other features of the invention will become apparent when taken in consideration with the following detailed description and the drawings.

### BRIEF DESCRIPTION OF THE DRAWINGS

FIG. 1 is a side view of a conventional shopping cart with the shopping cart extender of the instant invention installed;

FIG. 2 is a front view of a conventional shopping cart with the shopping cart extender of the instant invention installed;

FIG. 3 is a detail side view of the shopping cart extender of the instant invention; and

FIG. 4 is a detail front view of the shopping cart extender of the instant invention.

### DESCRIPTION OF A PREFERRED EMBODIMENT

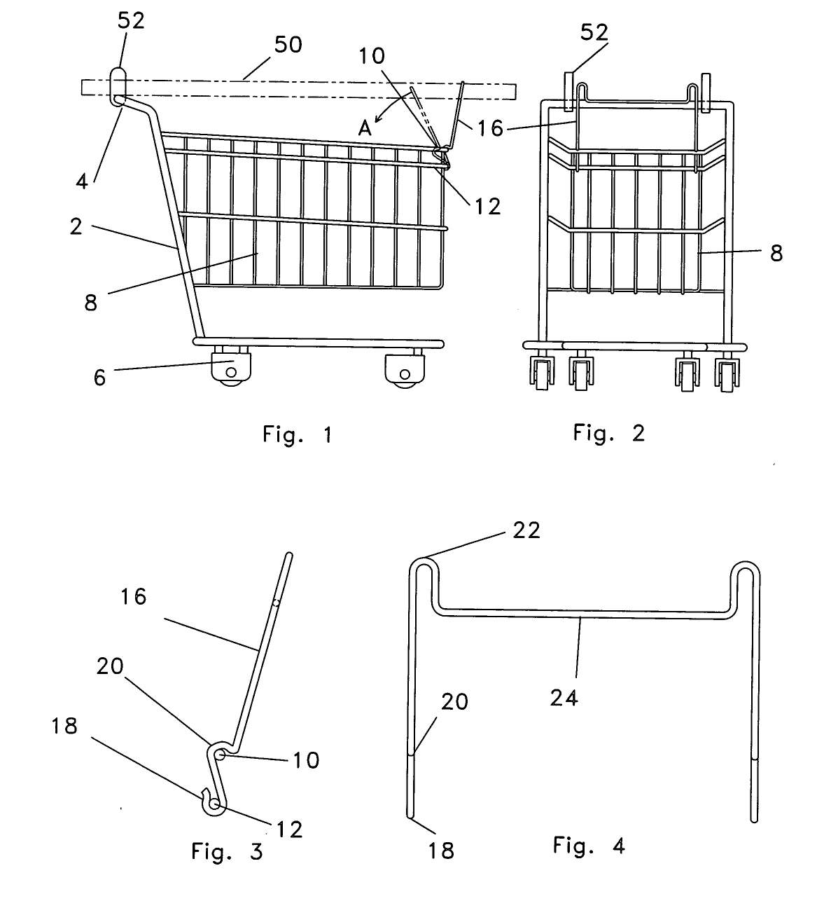

Referring to the drawings, FIGS. 1 through 4, there is shown a preferred form of the shopping cart extender embodying the present invention. The shopping cart extender of the instant invention is intended to be used as an attachment which may be installed on a conventional shopping cart. The shopping cart is not considered to be a part of the invention. A conventional shopping cart is assumed to include a frame which includes a handle at the top rear of the shopping cart. A plurality of caster type wheels (usually four) are affixed to the base of the shopping cart. The shopping cart also includes a basket which is made from welded wire. In order that the shopping carts may be nested, the basket and frame of the shopping cart gradually get smaller from rear to front and the top of the forward end of the basket of the shopping cart is lower than the top of the handle. The longitudinal plane of the shopping cart is considered a vertical plane passing through the midpoint of the handle of the shopping cart.

Referring to FIG. 1, a side view of a conventional shopping cart with the shopping cart extender of the instant invention installed is shown. The shopping cart includes a frame 2 which is often made from tube steel. The frame 2 includes a handle 4 which is at the top rear of the shopping cart. A plurality of wheels 6 (usually two fixed in the rear and two caster type wheels in the front) is affixed to the base of said frame 2. A basket 8 is affixed to said frame 2 of the shopping cart. The basket 8 has the general shape of an open topped box and is ordinarily made from welded wire. Said basket 8 is affixed forward of the handle 4 and above the wheels 6. Said basket 8 includes a top bar 10 which runs around the top circumference of said basket 8 and is roughly horizontal and rectangular. Said basket 8 includes a second top bar 12 which has the same general shape as the top bar 10 and is located slightly beneath said top bar 10. The shopping cart extender 16 of the instant invention is rotatably affixed to the front portion of the second top bar 12 of the shopping cart. A typical long item 50 is shown as being carried upon said handle 4 and the shopping cart extender 16.

Referring now to FIG. 2, a front view of a shopping cart with the shopping cart extender 16 of the instant invention installed is shown. This view shows that the front of said basket 8 is smaller than the rear of said basket 8 and that the front of said frame 2 of the shopping cart is smaller than the rear of said frame 2 of the shopping cart. This view also shows the position and configuration of said shopping cart extender 16.

Now referring to FIG. 3, a detail side view of said shopping cart extender 16 is shown. The bottom of said shopping cart extender 16 is bent into the shape of a hook 18 which opens rearward and upward. The hook 18 is bent in a plane perpendicular to the longitudinal axis of the shopping cart and the opening of said hook 18 is slightly smaller than the diameter of said second top bar 12. Thus, said hook 18 may be removably pressed onto said second top bar 12 and said shopping cart extender 16 rotatably affixed to said second top bar 12. Said shopping cart extender 16 is bent forward and downward such that a catch 20 is formed. The catch 20 is above said hook 18 and said catch 20 wraps around said top bar 10. Said catch 20 wraps sufficiently far around said top bar 10 that when said shopping cart extender 16 is rotated upward and forward about said second top bar 12, said catch 20 snaps onto said top bar 10 and holds said shopping cart extender 16 in a position which is slightly forward of vertical. There is a hook 18 and a catch 20 on both ends of said shopping cart extender 16.

Now referring to FIG. 4, a front view of the shopping cart extender 16 is shown. Above said hook 18 and said catch 20, is a holder 22. The holder 22 has the shape of an inverted “U” which opens downward. When said shopping cart extender 16 is in an upright position, the top of said holder 22 is slightly higher than the top of said handle 4. There is a holder 22 above each of said catches 20. A carrier 24 runs between the inner legs of each of said holders 22. The carrier 24 is horizontal and the top of said carrier 24 is level with the height of the top of said handle 4.

In operation, said shopping cart extender 16 is rotated rearward and downward about said second top bar 12 such that said shopping cart extender 16 is inside said basket 8 and said shopping cart extender 16 is roughly parallel with and touching the inside surface of the front of said basket 8. The operator may rotate said shopping cart extender 16 upward and forward about said second top bar 12 until said catch 20 engages said top bar 10. This holds said shopping cart extender 16 in a position which is slightly forward of vertical with said holders 22 extending upward slightly higher than the top of said handle 4 and said carrier 24 parallel to said handle 4 and with the top of said carrier 24 level with the top of said handle 4. The operator may then carry items too long to fit within said basket 8 by resting them upon the top of said handle 4 and the top of said carrier 24. Said holders 22 act to prevent such long items from sliding off of said carrier 24. When the shopping cart is no longer in use, it may be nested with other shopping carts in the usual manner. When the shopping cart is pushed through the rear of another shopping cart, the handle of the other shopping cart engages said shopping cart extender 16 and disengages said catch 20. This allows said shopping cart extender 16 to rotate rearward and downward and out of the way. This action of said shopping cart extender 16 is depicted by the phantom line image of said shopping cart extender 16 in FIG. 1 with the direction of movement indicated by arrow A.

In the preferred embodiment of the shopping cart extender of the instant invention, the shopping cart extender is made from a single cylindrical, steel bar which is bent into the desired shape. Other materials having the same strength and rigidity as well as other manufacturing techniques could be used.

Although the shopping cart extender of the instant invention is discussed above as being an add-on to an existing cart, there is no reason the shopping cart extender couldn't be built into new shopping carts by original equipment manufacturers. In a second embodiment of the instant invention, ears 52 could be affixed to said handle 4 as shown in FIG. 1 to prevent items from sliding sideways off of said handle 4. The ears 52 would be affixed to either end of said handle 4 and protrude upward from said handle 4.

While preferred embodiments of this invention have been shown and described above, it will be apparent to those skilled in the art that various modifications may be made in these embodiments without departing from the spirit of the present invention.

1. A shopping cart extender for use in conjunction with a conventional shopping cart, such shopping cart having a rearward end which is hinged and capable of swinging inward, a handle on the top rearward end, and a tapered front portion such that the front of one shopping cart may be pushed into the interior of another shopping cart through the rearward end and the shopping carts nested to take up less space when not in use, and the shopping cart having a longitudinal plane which is vertical and passes through the midpoint of the handle of the shopping cart which comprises:
(1) a bar which is generally in the shape of an open rectangle and which is rotatably affixed to the top front of the shopping cart and is perpendicular to the longitudinal plane of the shopping cart; and
(2) engagement means such that the bar may be rotated upward and forward and secured in a vertical position such that the top of said bar is level with the top of the handle of the shopping cart and such that when the shopping cart is nested with another shopping cart said bar disengages and rotates rearward and downward into the shopping cart;
whereby an operator may engage the shopping cart extender in a vertical position and, because the top of the handle and the top of the shopping cart extender are level, conveniently carry long loads resting on the top of the handle and the top of the shopping cart extender.

2. The shopping cart extender of claim 1 in which said bar is engaged forward of vertical.

3. The shopping cart extender of claim 1 in which said bar is engaged rearward of vertical.

4. The shopping cart extender of claim 1 in which a stop protrudes upward from each end of the top of said bar, where upward is with the shopping cart extender engaged.

5. The shopping cart extender of claim 2 in which a stop protrudes upward from each end of the top of said bar, where upward is with the shopping cart extender engaged.

6. The shopping cart extender of claim 3 in which a stop protrudes upward from each end of the top of said bar, where upward is with the shopping cart extender engaged.

7. The shopping cart extender of claim 1 in which an ear protrudes upward from each end of the handle of the shopping cart.

8. The shopping cart extender of claim 2 in which an ear protrudes upward from each end of the handle of the shopping cart.

9. The shopping cart extender of claim 3 in which an ear protrudes upward from each end of the handle of the shopping cart.

10. The shopping cart extender of claim 4 in which an ear protrudes upward from each end of the handle of the shopping cart.

11. The shopping cart extender of claim 5 in which an ear protrudes upward from each end of the handle of the shopping cart.

12. The shopping cart extender of claim 6 in which an ear protrudes upward from each end of the handle of the shopping cart.
